(19) United States
(12) Patent Application Publication
(10) Pub. No.: US 2008/0116748 A1
(43) Pub. Date: May 22, 2008

(54) Multi-function power storage device

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/600,915

(22) Filed: Nov. 17, 2006

(51) Int. Cl. H02J 7/02

(52) U.S. Cl. 307/66

(57) ABSTRACT

A multi-function power storage device comprises a socket means and a rechargeable battery. The socket means has a power plug, at least a socket, and a coupling switch mounted thereon. An inverter and an automatic switch are mounted in the rechargeable battery. The rechargeable battery has a corresponding coupling switch, a charge gauge, and at least an output terminal mounted on the outside. The socket means can be coupled with the rechargeable battery by using the coupling switches, and the power plug can be inserted into an indoor socket for indoor use so that other electric appliance's plug can be inserted into the socket means and the rechargeable battery can be charged simultaneously. As a result, the multi-function power storage device becomes an uninterruptible power supply system during a power failure. In addition, the rechargeable battery can be carried to the outsides for charging the car or other electric appliances urgently.

### FIELD OF THE INVENTION

The present invention relates to a multi-function power storage device, and more particularly to a multi-function power storage device suitable for use in indoor precision instruments and outdoor electric appliances.

### BACKGROUND OF THE INVENTION

Machines require stability and continuation for operation. To solve the power shortage problem, which occurs frequently in recent years, the power supply service must control by the power supply departments. When a power failure occurs, the software program and the data of the machines in process may be thus damaged, causing serious affection to all trades and professions that require extremely high data security. In addition, the expensive motherboard and central processing units (CPUs) of the highly sophisticated instruments may be damaged by the sudden voltage change caused by the power failure.

For the purpose of reducing the damage loss of the highly sophisticated instruments, an uninterruptible power supply (UPS) system, which is a backup power system for storing electric power and keeping the constant voltage and frequency of the electric instruments, is disclosed. The UPS system is generally composed of a rechargeable battery and an inverter. When in use, the UPS system is connected to the commercial power and the electric instruments are then connected with the UPS system, wherein the UPS system is a load of the electrified power network. When the commercial power is interrupted suddenly, the UPS system can supply the electric instruments with the stored electric power to enable the electric instruments to work normally.

The UPS system enables the electric instruments to work normally during the power failure so as to provide the user with sufficient time to backup the data or wait for the restoration of the commercial power service, but the occurrence of power failure is very sudden and rare. The UPS system is always placed against the wall silently to wait for the occurrence of next power failure. Therefore, the UPS system is only workable during the power failure so it is not ideal.

In view of the foregoing description, the motive of the present invention is to provide the general public with a multi-function power storage device for indoor and outdoor use.

### SUMMARY OF THE INVENTION

It is a principal object of the present invention to provide a multi-function power storage device for indoor and outdoor use.

In order to achieve the above-mentioned objects, a multi-function power storage device is comprised of a socket means and a rechargeable battery. The socket means has a power plug, at least a socket, and a coupling switch mounted thereon. The rechargeable battery has an inverter and an automatic switch mounted therein. The rechargeable battery has a corresponding coupling switch, a charge gauge, and at least an output terminal mounted on the outside. As a result, the socket means can be coupled with the rechargeable battery by using the coupling switches, and the power plug can be inserted into an indoor socket for indoor use so that other electric appliance's plug can be inserted into the socket means and the rechargeable battery can be charged simultaneously. Accordingly, the multi-function power storage device becomes an uninterruptible power supply (UPS) system during the interruption of commercial power service. In addition, it is unnecessarily to pull out the electric appliance's plug from the socket means when the socket means is detached from the rechargeable battery, and the rechargeable battery can be carried to the outsides for charging the car or other electric appliances urgently.

The aforementioned objects and advantages of the present invention will be readily clarified in the description of the preferred embodiments and the enclosed drawings of the present invention.

### BRIEF DESCRIPTION OF THE DRAWINGS

FIG. 1 is an elevational view showing a preferred embodiment of the present invention.

FIG. 2 is a schematic disassembled view showing the components of the preferred embodiment of the present invention.

FIG. 3 is a schematic view showing the usage of the preferred embodiment of the present invention.

FIG. 4 is another schematic view showing the usage of the preferred embodiment of the present invention.

### DETAILED DESCRIPTION OF THE PREFERRED EMBODIMENT

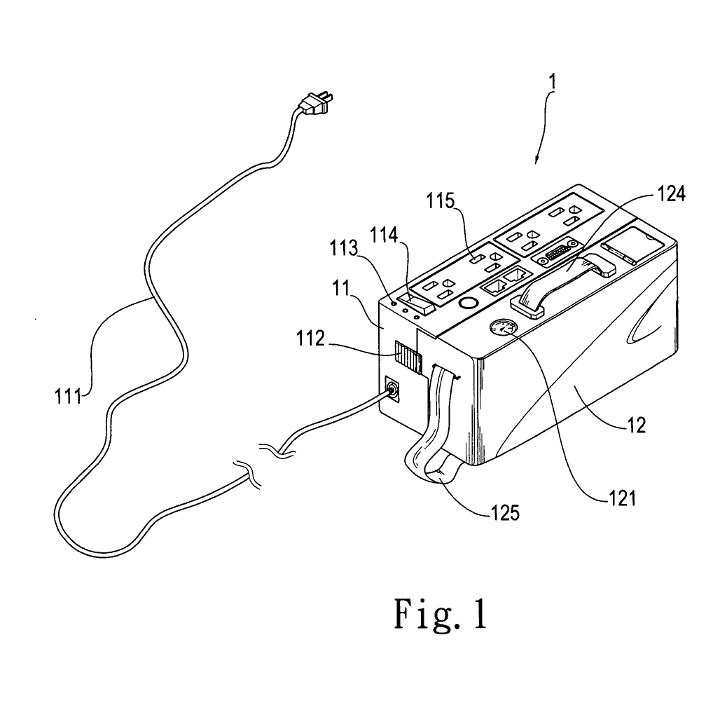

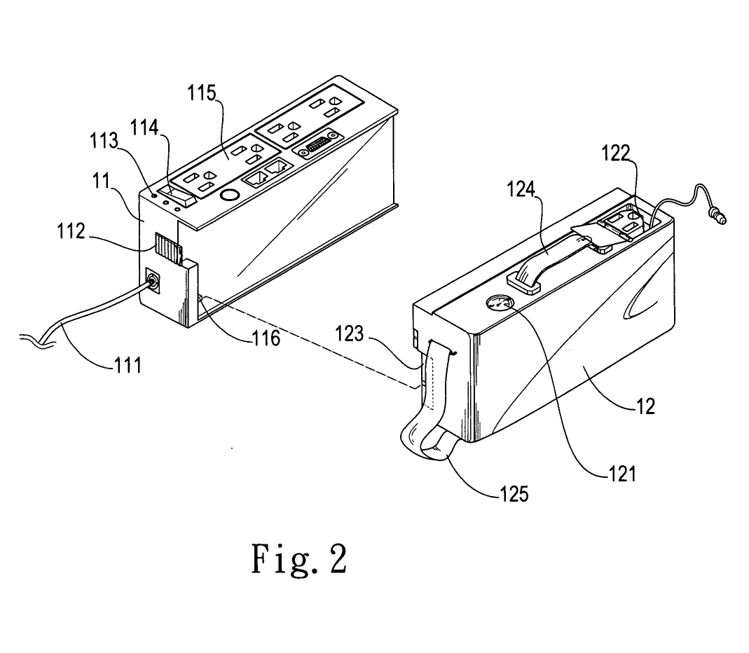

Referring to FIGS. 1 and 2, a multi-function power storage device 1 of the present invention comprises a socket means 11 and a rechargeable battery 12. The socket means 11 has a power plug 111, a coupling switch 112, several indicator lights 113, a control switch 114, at least a socket 115 (four sockets in this preferred embodiment), and a battery output terminal 116. The socket means 11 has a respective protrudent portion extending from upper edge and lower edge of the same side of the socket means 11 as the battery output terminal 116.

An inverter and an automatic switch (not shown) are mounted in the rechargeable battery 12, wherein the automatic switch is a relay, a sensor, or a software program. The automatic switch is to detect the disconnection status or the connection status between the rechargeable battery 12 and the socket means 11. An input terminal 123, a charge gauge 121, and a liftable portion are mounted on the outside of the rechargeable battery 12. An input/output terminal 122 is disposed in the liftable portion. The input/output terminal 122 is a car-use cigar-lighter plug, a clip, or at least a socket for two-way input/output. In this preferred embodiment, the input/output terminal 122 is a car-use cigar-lighter plug. The input terminal 123 is located on one side of the rechargeable battery 12 to match the battery output terminal 116 of the socket means 11. In addition, two slots are formed respectively on upper edge and lower edge of the same side of the rechargeable battery 12 as the input terminal 123. Besides, a handle 124 and a belt 125 are mounted respectively on a top surface and two opposite sides of the rechargeable battery 12.

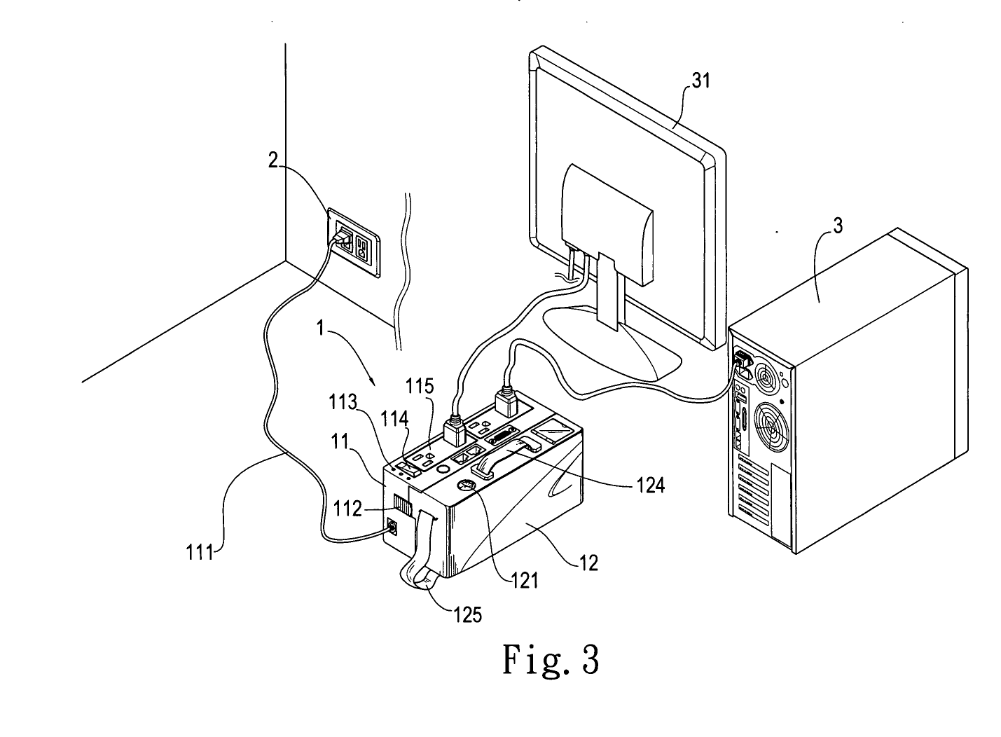

The protrudent portions of the socket means 11 are located to fact the slots of the rechargeable battery 12 so that the battery output terminal 116 of the socket means 11 can be coupled with the input terminal 123 of the rechargeable battery 12 so as to complete the multi-function power storage device 1. In addition, when applied indoors, as shown in FIG. 3, the power plug 111 can be inserted into an indoor socket 2, and a plug of a computer 3 and a plug of a monitor 31 can be inserted into the sockets 115 of the socket means 11. In addition, the indicator lights 113 and the control switch 114 are utilized to show the electrification status of the socket 115. Besides, the socket means 11 is connected with the rechargeable battery 12 in parallel so that the multi-function power storage device 1 of the present invention can supply the required electric power for booting the computer and the rechargeable battery 12 can be charged simultaneously. Accordingly, if the commercial power service is interrupted, the rechargeable battery 12 can switch on a power supply mechanism automatically to provide with sufficient time for storing the data before shutting down the computer.

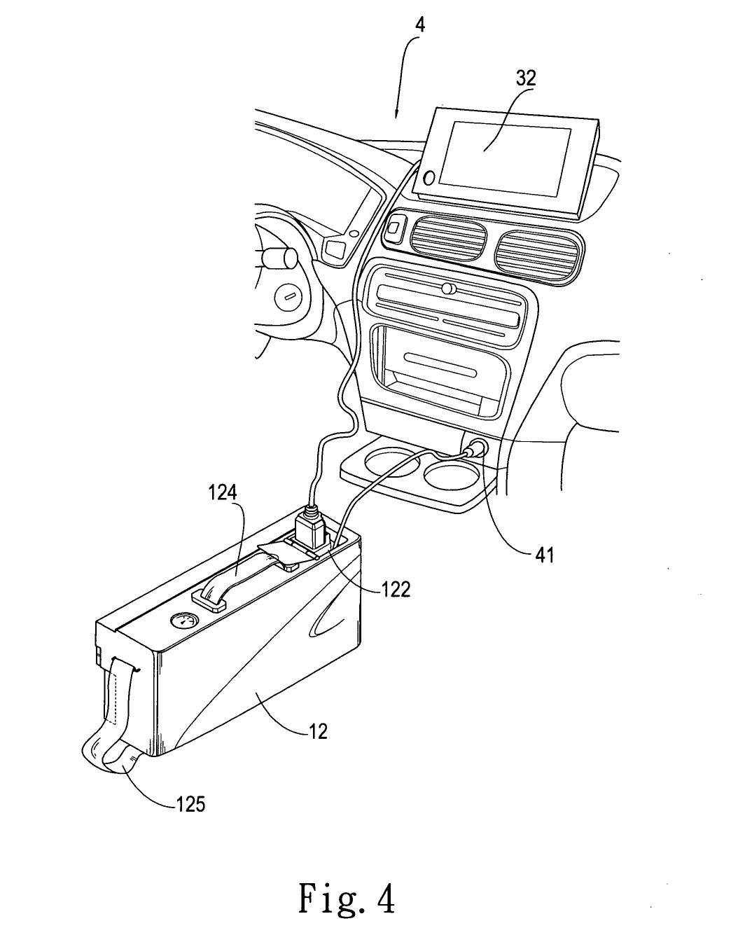

When the user wants to go to the outdoors, the rechargeable battery 12 can be separated from the socket means 11 by using the coupling switch 112. At this moment, it is unnecessarily to pull out the electric appliance's plug from the socket means 11. In addition, the rechargeable battery 12 has the handle 124 and the belt 125 so the user can hold and carry the rechargeable battery 12 easily. In addition, the user can check the amount of charge left in the rechargeable battery 12 via the charge gauge 121 and lift up the liftable portion of the rechargeable battery 12 for inserting a plug of other appliance such as a camping lantern into the socket of the input/output terminal 122. As a result, the camping lantern will light up by the rechargeable battery 12. If the remaining amount of charge is insufficient after a period of time, as shown in FIG. 4, the input/output terminal 122 of the rechargeable battery 12 is designed to be the car-use cigar-lighter plug for insertion into the car-use cigar-lighter so that the rechargeable battery 12 can be charged by a storage battery of a car 4 so as to supply the stored electric power for a personal digital assistant (PDA) 32. On the contrary, if the car 4 cannot be actuated because of exhaustion of the electric power stored in the storage battery of the car 4, the input/output terminal 122 of the rechargeable battery 12 is designed to be the car-use cigar-lighter plug for insertion into the car-use cigar-lighter 41 of the car 4 so as to allow the rechargeable battery 1 to charge the storage battery of the car 4.

In accordance with the foregoing description, the present invention has the following advantages:

1. The socket means can be easily attached to or detached from the rechargeable battery via the modular design so as to achieve diversified functions.

2. After coupling the socket means with the rechargeable battery, the socket means is connected with the commercial power service so as to allow the electric appliance that inserts into the socket means to be workable and allow the rechargeable battery to be charged simultaneously so that the rechargeable battery can output the stored electric power to enable the electric appliance to work persistently during the interruption of commercial power service.

3. When the user wants to carry the rechargeable battery for outdoor use, the coupling switch is utilized to separate the rechargeable battery from the socket means. As a result, it is convenient to use since there is no need to pull out the electric appliance's plug that inserts into the socket means.

4. The rechargeable battery has the handle and the belt so the user can hold the detached rechargeable battery easily or carry the detached rechargeable battery on the back easily.

In summary, the multi-function power storage device, which is disclosed in the present invention, indeed achieves the anticipated objects. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A multi-function power storage device, comprising:
a socket structure on which a power plug, at least a socket, and a first coupling part are mounted; and
a rechargeable battery having an inverter and an automatic switch mounted on the inside and having a corresponding second coupling part, a charge gauge, and at least an output terminal on the outside so that said socket structure can be attached to or detached from said rechargeable battery by using said first and second coupling parts
the socket structure forming one portion of a housing of the device, the rechargeable battery forming another portion of the housing of the device, the joining of the one portion to the another portion through the coupling of the first coupling part and the second coupling part forming the complete housing of the device.

2. A multi-function power storage device of claim 1, wherein said socket structure has a plurality of indicator lights and a control switch to control the electrification status of said at least a socket.

3. A multi-function power storage device of claim 1, wherein said first coupling part that mounts on a first side of said socket structure has an output terminal, and said socket structure has two protrudent portions respectively extending from upper edge and lower edge of said first side, wherein said second coupling part that mounts on a first side of said rechargeable battery has an input terminal, and said rechargeable battery has two slots formed respectively on upper edge and lower edge of said first side.

4. A multi-function power storage device of claim 1, wherein said automatic switch, which is mounted on the inside of said rechargeable battery, is a relay, a sensor, or a software program.

5. A multi-function power storage device of claim 1, wherein said rechargeable battery has a liftable portion having a trench for holding said at least an output terminal.

6. A multi-function power storage device of claim 1, wherein said at least an output terminal is a car-use cigar-lighter plug, a clip, or a socket.
